(19) United States
(12) Patent Application Publication
(10) Pub. No.: US 2006/0073322 A1
(43) Pub. Date: Apr. 6, 2006

(54) Low density spray polyurethane for automobile interior applications

(75) Inventors: Joseph T. Donatti, Howell, MI (US); Andrew P. Mellentine, Owosso, MI (US); Ian S. Williams, Howell, MI (US); Kenneth W. Shaner, Howell, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/956,842

(22) Filed: Oct. 1, 2004

(51) Int. Cl. B28B 7/38; B05D 1/02; B32B 3/26

(52) U.S. Cl. 428/304.4; 427/421.1; 427/133

(57) ABSTRACT

A method for forming a low density polyurethane skin for automobile interior applications is provided. The method of the invention comprises spraying an expandable polyurethane composition over a mold cavity surface or a mold cavity surface pre-coated with a primer polyurethane layer to form the low density polyurethane skin. A sufficient amount of the expandable polyurethane composition is sprayed so that the low density polyurethane skin has a thickness from about 0.5 to about 3 mils. The expandable polyurethane composition includes an isocyanate, a polyol, a blowing agent, an optional catalyst, and an optional surfactant. An article made by the method of the invention is also disclosed.

### BACKGROUND OF THE INVENTION

1. Field of the Invention

The present invention relates to methods and compositions for forming low density polyurethane for automobile interior applications.

2. Background Art

Polyurethane materials have been developed and implemented in processes used in manufacturing articles. For example, in the manufacture of automotive interior components, it has been proposed to form such components by spraying a gellified polyurethane material into a mold to form a skin that is later placed in a polyurethane foam forming mold and filled with structural polyurethane foam to form at least part of a finished part. Such a semiflexible polyurethane foam functions as filler and provides a soft feel to the part. Typical polyurethane skin are formulated to provide a specific density in the range for about 50 to 60 lb/ft³ (specific gravity ranging from about 0.95 to 1) and a Shore A hardness from about 50 to 80.

Standard polyurethane formulations that are used to form automobile interior components often incorporate various additives (i.e., blowing agents) that act to reduce the density of polyurethane skins. Such additives include, for example, water and gases such as Freons, nitrogen, and carbon dioxide. The gases are normally injected into the chemical mixture at a mixing head. In contrast, water is typically blended into the chemical composition. The problem of adding only water as a primary blowing catalyst is that water reacts with the isocyanate that is present in polyurethane formulation to form polyurea molecules and carbon dioxide. Incorporation of polyurea into polyurethane skins produces harder layers with hard segment domains with high load moduli. In some cases, this is desirable for polyurethane foams where high load bearing is needed. However, many automobile interior application require a softer feel.

U.S. Pat. No. 5,071,683 (the '683 patent) discloses a gellified polyurethane foam skin that is formed by combining a mixture of polyurethane reactants that are mixed under pressure in a spray gun and then sprayed as a mixture by a single nozzle in the form of a film and/or drops. In the '683 patent, a mixing chamber in the spray gun has an input for polyol and isocyanate components in which the polyol and the isocyanate are mixed in the mixing chamber with a high speed counter-current that is then dispensed through a nozzle. The nozzle is designed to form a truncated cone shaped spray that breaks apart into droplets prior to being deposited on a surface. This approach to form a gellified polyurethane skin suffers from the disadvantage of requiring frequent purging of the mix gun. U.S. Pat. Pub. 20040094865 discloses a spray nozzle in which the components of a polyurethane system are sprayed into an unconfined space above a mold. The approach disclosed in this publication avoids some of the plugging issues with the design of the '683 patent. Although these method of forming polyurethane layers for automobile applications work well, such process tend to be complex when multilayer structures are made. Moreover, there is an ever present desire to reduce consumption of the chemical components and reduce component costs.

Accordingly, there exists a need for improved and more economical processes for forming polyurethane skin layers that are incorporated into automobile interior components.

### SUMMARY OF THE INVENTION

The present invention solve one or more problems of the prior art by providing in at least one aspect a method of forming a low density polyurethane skin. The method of the invention comprises spraying an expandable polyurethane composition over a mold cavity surface or a mold cavity surface pre-coated with a primer polyurethane layer to form the low density polyurethane skin. A sufficient amount of the expandable polyurethane composition is sprayed so that the low density polyurethane skin has a thickness from about 0.5 to about 3 mils. The expandable polyurethane composition includes an isocyanate, a polyol, and a blowing agent. In some variations, the expandable polyurethane composition also includes a gelling catalyst and a surfactant. The blowing agent is present in a sufficient amount that the specific gravity of the low density polyurethane skin is from about 0.3 to about 0.75 g/cm³.

In another embodiment of the invention, a low density polyurethane skin made by the method of the invention is provided. The low density polyurethane skin includes residues of the polymerization product formed from the expandable polyurethane composition. Specifically, the low density polyurethane skin comprises residues of isocyanate, polyol, blowing agent, and any other option additive included in the expandable polyurethane composition as set forth above.

### BRIEF DESCRIPTION OF THE DRAWINGS

FIG. 1 is a cross section of an article made by an embodiment of the present invention;

FIG. 2 is cross section of an article having a two layer polyurethane skin made by the method of the invention;

FIG. 3 is a schematic of an embodiment of the invention in which a two layered polyurethane skin is made; and

FIG. 4 is a schematic illustrating metering of the components in the polyurethane layers made by the methods of the invention.

### DETAILED DESCRIPTION OF THE PREFERRED EMBODIMENT(S)

Reference will now be made in detail to the presently preferred compositions or embodiments and methods of the invention, which constitute the best modes of practicing the invention presently known to the inventors.

In an embodiment of the invention, a method for forming a low density polyurethane skin for automobile interior applications is provided. The method of the invention comprises spraying an expandable polyurethane composition over a mold cavity surface or a mold cavity surface pre-coated with a primer or in-mold colorant (“IMC”) polyurethane layer to form the low density polyurethane skin. The IMC polyurethane layer may be either a 1 K (catalyzed) or 2 K (uncatalyzed) system. A sufficient amount of the expandable polyurethane composition is sprayed so that the low density polyurethane skin has a thickness from about 0.5 to about 3 mils. The expandable polyurethane composition includes an isocyanate, a polyol, and a blowing agent. The blowing agent is present in a sufficient amount that the specific gravity of the low density polyurethane skin is from about 0.3 to about 0.75 g/cm³. In another variation of the invention, blowing agent is present in a sufficient amount that the specific gravity of the low density polyurethane skin is from about 0.3 to about 0.5 g/cm³.

As set-forth above, the low density polyurethane skin formed by the method of the invention includes an expanded skin layer. As used herein, “expanded skin layer” means a skin layer having a cellular structure. Typically, the low density polyurethane skin formed by the method of the invention has a specific gravity from about 0.35 to about 0.90 as determined by ASTM D792 and a thickness from about 0.5 to about 3 mils. In a variation of the invention, the low density polyurethane skin formed by the method of the invention has a specific gravity from about 0.48 to about 0.80 as determined by ASTM D792. In another variation of the invention, the low density polyurethane skin formed by the method of the invention has a specific gravity from about 0.55 to about 0.70 as determined by ASTM D792. Similarly, in variations of the invention, the thickness of the low density polyurethane skin is from about 0.8 to about 1.5 mils. In addition, the low density polyurethane skin of the invention is further characterized by its Shore A hardness which is typically between 25 and 60. In a variation of the invention, the low density polyurethane skin of the invention is further characterized by its Shore A hardness which is typically between 30 and 50.

Suitable isocyanates and polyol for use in the method of the invention are commercially available from Dow Chemical Company and BASF Corporation. Typically, the polyol is present in an amount in an amount from about 40% to about 80% of the total weight of the expandable polyurethane composition and the isocyanate is present in an amount from about 20% to about 60% of the total weight of the expandable polyurethane composition. In a variation of the invention, the polyol is present in an amount in an amount from about 50% to about 70% of the total weight of the expandable polyurethane composition and the isocyanate is present in an amount from about 30% to about 50% of the total weight of the expandable polyurethane composition. In yet another variation of the invention, the polyol is present in an amount in an amount from about 60% to about 65% of the total weight of the expandable polyurethane composition and the isocyanate is present in an amount from about 35% to about 40% of the total weight of the expandable polyurethane composition.

The expandable poluyurethane composition used in the method of the invention includes one or more blowing agents. Examples of blowing agents that are used in the methods of the invention include, but are not limited to, Air Products Dabco BL-11, BL-17, and BL-22. These blowing agents are used in combination with water to generate carbon dioxide. Delayed blowing catalysts such as Dabco BL-17 are designed for use in flexible polyurethane foam systems. Such blowing agents are chemically blocked to reduce its catalytic effect during the early stages of the polyurethane polymerization. As polymerization progresses the catalyst deblocks thereby promoting maximum activity. Another advantage of using such a delayed blowing agent is to allow the polyurethane to flow before it significantly crosslinks. It should also be appreciated that delayed blowing agents do not significantly increase the overall cure time for a part. Dabco BL-11 and BL-22 work in a similar fashion providing open cell foam with slightly different results in reactivity depending upon the desired product and process requirements. Dabco BL-11 is a strong blowing agent consisting of 70% bis(dimethylaminoethyl)ether and 30% Dabco BL-17. Dabco BL-22 is also an acid blocked delayed amine blowing catalyst. Dabco BL-22 also acts to promote a faster cure and must be balanced with other blowing catalyst to achieve the desired final density and hardness.

The specific amount of catalyst and water varies depending on the foam density and hardness required. Typically, the amount of catalyst ranges from about 0.5 part per 100 parts of polyol to about 5.0 parts per 100 parts of polyol. The amount of water which is combined with the blowing catalyst also depends on the desired skin properties. Typically, the amount of water ranges from about 1.0 part per 100 parts of polyol to about 10.0 parts per 100 parts of polyol.

The expandable polyurethane composition of the present invention optionally further comprises at least one cell opener. Suitable cell openers include for example silicone surfactants or oils such as Tegostab 8715LF and Tegostab 8905 available from Goldschmidt Chemical Corporation located in Hopewell, Va. The cell opener will typically be present in an amount from about 0.01% to about 2% of the total weight of the first polyurethane composition. In other variations of the invention, the cell opener is present in an amount from about 0.3 to about 0.5% of the total weight of the first polyurethane composition. When Tegostab 8905 is used an amount of from about 0.1 to about 0.5 works well.

The expandable polyurethane composition optionally comprises other additives. Such other additives include, for example, colorants, flame retardants, internal mold release agents, acid scavengers, water scavengers, cell regulators, pigments, dyes, UV stabilizers, fungistatic or bacteriostatic substances, fillers, and catalysts, including various blowing agents some of which may be reative, thile other are non-reactive. An examples of a catalyst that may be included is Bi-Cat 8 which is a bismuth/zinc neodecanoate mixture available from Shepard Chemical located in Cinncinatti, Ohio. When present, this catalyst is typically present in an amount from about 0.10% to about 1% of the total weight of the expandable polyurethane composition (or from about 0.1 to about 1 parts per 100 parts of polyol).

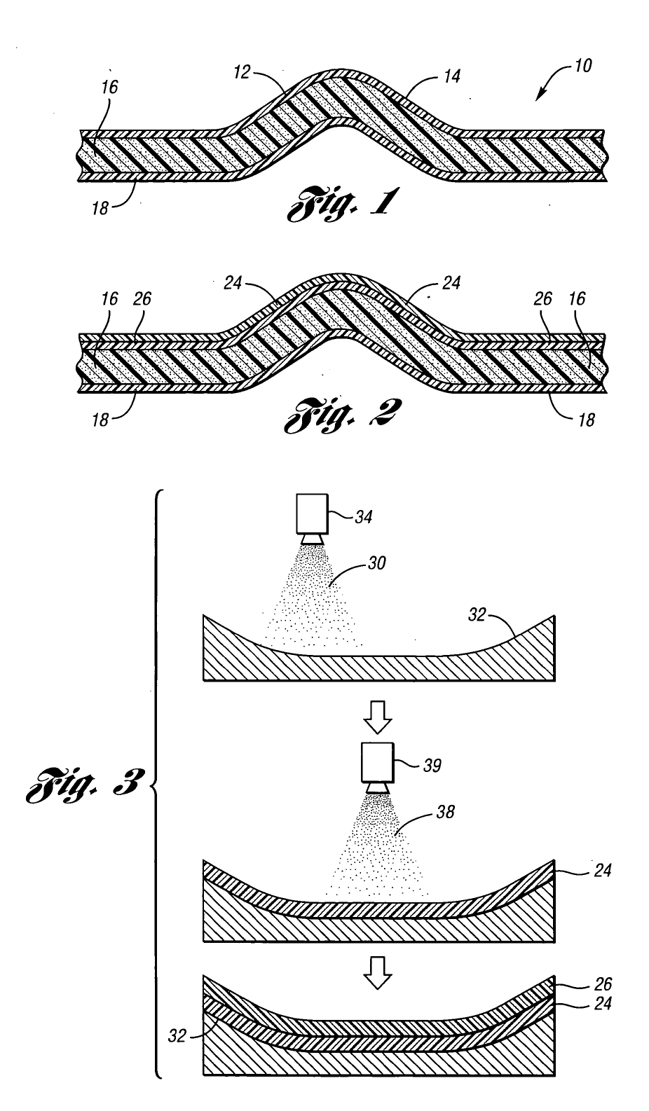

With reference to FIG. 1, a cross section of an article made by a variation of the invention is provided. Automobile interior component 10 includes low density skin layer 12 which is a single expanded polyurethane layer (i.e., low density polyurethane skin layer 12 is cellular throughout). In this variation, surface 14 of low density skin layer 12 forms the visible exterior surface of automobile interior component 10. Automobile component 10 also includes a backing foam 16 disposed behind at least a portion of skin layer 12 and rigid structural member 18 disposed behind one or more sections of foam backing 14. In accordance with the method of the invention, low density skin layer 12 is formed by spraying the expandable polyurethane composition over a mold cavity surface as set forth above.

With reference to FIG. 2, a cross section of an article made by another variation of the invention is provided. Automobile interior component 20 includes low density skin layer 22 which includes solid polyurethane skin 24 and expanded skin layer 26 disposed behind solid polyurethane skin 24. In this variation a surface of solid polyurethane skin 24 forms the visible exterior surface of automobile interior component 10. This variation is characterized in that solid polyurethane skin 24 is more dense than expanded layer 26. Moreover, solid polyurethane skin 24 is less cellular (has less cells or pores) than expanded polyurethane layer 26. Automobile component 20 also includes a backing foam 16 disposed behind at least a portion of expanded skin layer 26 and rigid structural member 18 disposed behind one or more sections of foam backing 16. In should be appreciated that in this variation, the thickness of the low density the sum of the thickness of solid polyurethane skin 24 and expanded skin layer 26. Accordingly, the thickness of solid polyurethane skin 24 is from about 0.25 mil to about 1.5 mil and the thickness of expanded skin layer 26 is from about 0.25 mil to about 1.5 mil.

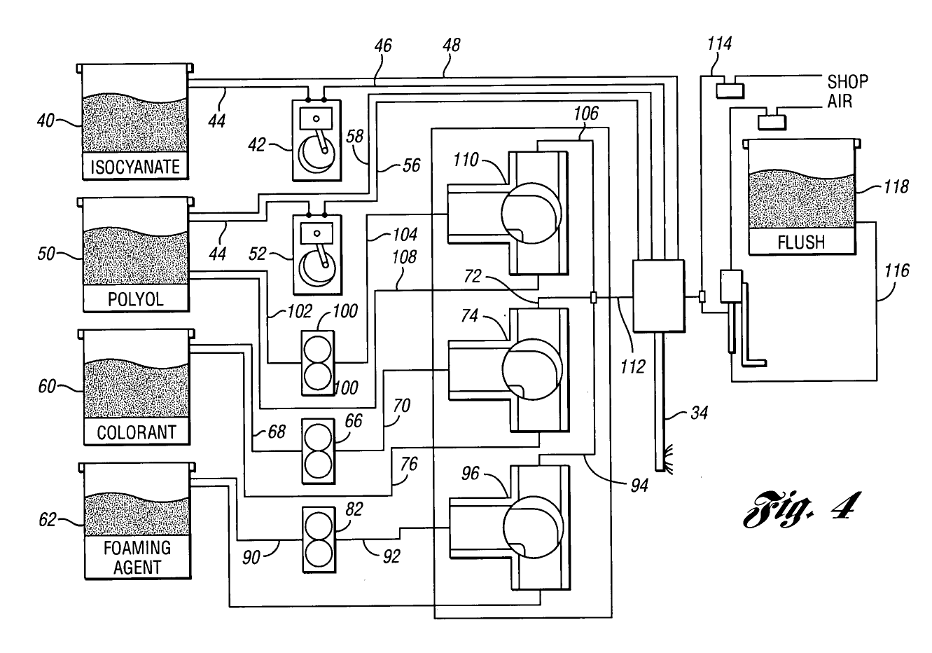

With reference to FIG. 3, a schematic illustrating the method for forming the variation of FIG. 2 is provided. Solid polyurethane skin 24 is formed by spraying first polyurethane composition 30 over mold surface 32. Sprayer 34 is used to spray the components of first polyurethane composition 32 which include a first isocyanate and a first polyol. Typically, the first isocyanate and the first polyol are kept separate to avoid pre-reaction of the components before reaching mold surface 32. These components are mixed just prior spraying in a mixing chamber that is either part of sprayer 34 or in close proximity to sprayer 34. A useful sprayer is disclosed in U.S. Pat. No. 5,071,683, the entire disclosure of which is hereby incorporated by reference. Another useful spray nozzle is also disclosed in U.S. Pat. Pub. 20040094865, the entire disclosure of which is hereby incorporated by reference. Details of the combination of the polyurethane components are set forth above.

In a variation of the invention, first polyurethane composition 30 includes the polyol in an amount in an amount from about 40% to about 80% of the total weight of first polyurethane composition 30 and the isocyanate in an amount from about 20% to about 60% of the total weight of first polyurethane composition 30. In a variation of the invention, first polyurethane composition 30 includes the polyol in an amount in an amount from about 50% to about 70% of the total weight of first polyurethane composition 30 and the isocyanate in an amount from about 30% to about 50% of the total weight of first polyurethane composition 30. In yet another variation of the invention, first polyurethane composition 30 includes the polyol in an amount in an amount from about 60% to about 65% of the total weight of first polyurethane composition 30 and the isocyanate is present in an amount from about 35% to about 40% of the total weight of first polyurethane composition 30. First polyurethane composition 32 optionally further includes a cell opener and other additives such as colorants, flame retardants, internal mold release agents, acid scavengers, water scavengers, cell regulators, pigments, dyes, UV stabilizers, plasticizers, fungistatic or bacteriostatic substances, and fillers.

Still referring to FIG. 3, after solid polyurethane skin 24 has formed, expanded skin layer 26 is formed by spraying second polyurethane composition (the expandable polyurethane composition set forth above) 38 through sprayer 34 over solid polyurethane skin 24 which is disposed over mold surface 32. Second polyurethane composition 38 includes a second isocyanate, a second polyol, and a blowing agent as set forth above for the expandable polyurethane composition. Typically, the second isocyanate and a first portion of the polyol are kept separate and mixed just prior to spraying in a mixing chamber that is either part of sprayer 34 or in close proximity to sprayer 34. Advantageously, the first and second isocyanates are the same and the first and second polyols are the same thereby allowing the first and second polyurethane skins to be sprayed through the same sprayer 34. The utilization of the same sprayer for formation of solid polyurethane skin 24 and expanded polyurethane layer 26 allows significant process simplification over multilayer processes that require separate sprayers for each layer. Moreover, the present invention allows expanded polyurethane layer 26 to be formed over solid polyurethane skin 24 without first removal of solid polyurethane skin 24 from mold surface 32.

With reference to FIG. 4, a schematic demonstrating the metering of the components for first polyurethane composition 30 and second polyurethane composition 38 is provided. Each of the components of the polyurethane layers formed by the methods of the invention are introduced into sprayer 34. Isocyanate from isocyanate source 40 is pumped into sprayer via gear pump 42 through lines 44, 46, 48. Polyol from polyol source 50 is pumped into sprayer 34 via gear pump 52 via lines 54, 56, 58. When the polyurethane layers formed from the method of the invention includes either a colorant and/or a foaming agent sources 60, 62 are utilized. An optional colorant from colorant source 60 is pumped into sprayer 34 by the action of gear pump 66 via lines 68, 70, 72 and three-way valve 74. Return line 76 is a return line used when three-way 74 valve is in the off position. Similarly, foaming agent from foaming agent source 62 is pumped into sprayer 34 by the action of gear pump 82 via lines 90, 92, 94 and three-way valve 96. Return line 98 is a return line used when three-way valve 96 is in the off position. A portion of the polyol is combined with the colorant and/or blowing agent via gear pump 100 and lines 102, 104, 106 to provide sufficient volume for spraying. Return line 108 is a return line used when three-way 110 valve is in the off position. The colorant, the blowing agent and a portion of the polyol are combined and flowed into sprayer 34 via line 112. Air is flowed into sprayer 34 via line 114. Moreover, sprayer 34 may be purged via line 116 supplied by solvent from solvent source 118.

In another embodiment of the invention, a low density polyurethane skin made by the methods set forth above is provided. Specifically, the low density polyurethane comprises residues of an expandable polyurethane composition that includes an isocyanate, a polyol, and a blowing agent. The details of each of these components is the same as those set forth above. In a particularly preferred variation, the low density polyurethane skin comprises a first polyurethane layer and a second polyurethane layer. The first polyurethane layer comprises residues of a polymerization reaction from a first polyurethane composition that comprises a first isocyanate and a first polyol. Similarly, the second polyurethane layer comprises residues of a polymerization reaction from a second polyurethane composition that comprises an isocyanate, a polyol, and a blowing agent present. Again, the details of the first and second polyurethane compositions is set forth above. In particular, the blowing agent is in a sufficient amount that the specific gravity of the low density polyurethane skin is from about 0.3 to about 0.5 g/cm3.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for forming a low density polyurethane skin that includes an expanded skin layer and an optional primer polyurethane layer, the method comprising:
spraying an expandable polyurethane composition over a mold cavity surface or a mold cavity surface pre-coated with the primer polyurethane layer to form the low density polyurethane skin, the expandable polyurethane composition comprising:
an isocyanate;
a polyol; and
a blowing agent present in a sufficient amount that the specific gravity of the low density polyurethane skin is from about 0.3 to about 0.75 g/cm³;
wherein an amount of the expandable polyurethane composition is sprayed so that the low density polyurethane skin has a thickness from about 0.5 to about 3 mils.

2. The method of claim 1 wherein the low density polyurethane skin has a Shore A hardness from about from about 30 to about 50.

3. The method of claim 1 wherein the polyol is present in an amount in an amount from about 40% to about 80% of the total weight of the expandable polyurethane composition and the isocyanate is present in an amount from about 20% to about 60% of the total weight of the expandable polyurethane composition.

4. The method of claim 1 wherein the blowing agent comprises a chemically blocked blowing catalyst that is reacted with water.

5. The method of claim 1 wherein the polyol is present in an amount in an amount from about 60% to about 65% of the total weight of the expandable polyurethane composition and the isocyanate is present in an amount from about 35% to about 40% of the total weight of the expandable polyurethane composition.

6. The method of claim 1 further comprising a colorant.

7. The method of claim 1 further comprising a cell opener.

8. A method for forming a low density polyurethane for automobile interior applications, that includes a first polyurethane layer and a second polyurethane layer, the method comprising:
spraying a first polyurethane composition over a mold surface to form the first polyurethane layer disposed over the mold surface, the first polyurethane having the a first density and the first composition comprising:
a first isocyanate;
a first polyol; and
cell opener;
spraying a second polyurethane composition over the first polyurethane layer to form the second polyurethane layer disposed over the first polyurethane layer, the second polyurethane layer having a second density that is lower than the first density and the second composition comprising:
a second isocyanate;
a second polyol; and
a blowing agent;
wherein the second polyurethane is sprayed while the first polyurethane is still disposed over the mold substrate and the first polyol and the second polyol are the same and the fist isocyanate and the second isocyanate are the same.

9. The method of claim 8 wherein the first isocyanate and the first polyol are separately flowed to a spray and then mixed in the spray prior to spraying of the first polyurethane composition.

10. The method of claim 9 wherein the second isocyanate, a first portion of the second polyol, and a mixture comprising a second portion of the second polyol and the blowing agent are separately flowed to a sprayer and then mixed in the spray prior to spraying of the second polyurethane composition.

11. The method of claim 8 wherein the first polyurethane layer has a specific gravity from about 45 to about 65 lb/ft².

12. The method of claim 8 wherein the low density polyurethane skin has a density from about from about 30 to about 50 lb/ft².

13. The method of claim 8 wherein the low density polyurethane has a Shore A hardness from about from about 30 to about 50.

14. The method of claim 8 wherein the first polyol is present in an amount from about 40% to about 80% of the total weight of the first polyurethane composition and the first isocyanate is present in an amount from about 20% to about 60% of the total weight of the first polyurethane composition and the second polyol is present in an amount from about 40% to about 80% of the total weight of the second polyurethane composition and the second isocyanate is present in an amount from about 20% to about 60% of the total weight of the second polyurethane composition.

15. The method of claim 8 wherein the second polyol is present in an amount from about 40% to about 80% of the total weight of the second polyurethane composition and the second isocyanate is present in an amount from about 20% to about 60% of the total weight of the second polyurethane composition and the second polyol is present in an amount from about 40% to about 80% of the total weight of the second polyurethane composition and the second isocyanate is present in an amount from about 20% to about 60% of the total weight of the second polyurethane composition.

16. The method of claim 8 wherein the blowing agent comprises a chemically blocked blowing catalyst that is reacted with water.

17. The method of claim 8 wherein the expandable polyurethane composition further comprises a colorant.

18. The method of claim 8 wherein the expandable polyurethane composition further comprises a cell opener.

19. A low density polyurethane skin comprising:
a first polyurethane layer comprising residues of a polymerization reaction from a first polyurethane composition, the first polyurethane composition comprising a first isocyanate and a first polyol; and
a second polyurethane layer comprising residues of a polymerization reaction from a second polyurethane composition, the second polyurethane composition comprising an isocyanate, a polyol, and a blowing agent present, wherein the blowing agent is in a sufficient amount that the specific gravity of the low density polyurethane skin is from about 0.3 to about 0.75 g/cm³.

20. The low density polyurethane skin of claim 19 wherein the first and second polyurethane compositions each independently further comprise a cell opener.
